(19) United States
(12) Patent Application Publication
(10) Pub. No.: US 2005/0265613 A1
(43) Pub. Date: Dec. 1, 2005

(54) Image coding apparatus and method, and image decoding apparatus and method

(76) Inventors: Takahiro Fukuhara, Kanagawa (JP); Seiji Kimura, Chiba (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/050,620

(22) Filed: Feb. 2, 2005

(30) Foreign Application Priority Data
Feb. 13, 2004 (JP) P2004-037390

(51) Int. Cl. G06K 9/36; G06K 9/46

(52) U.S. Cl. 382/239; 382/240

(57) ABSTRACT

There is provided an image encoder (10) including a difference calculator (12) which substrates a wavelet transform coefficient (D17) of a preceding frame supplied from a memory (17) from a wavelet transform coefficient (D11) of a current frame to generate a difference coefficient (D12). The image encoder (10) includes also a selector (13) which selects one of the wavelet transform coefficient (D11) and difference coefficient (D12), whichever is smaller in absolute value sum over the frame and supplies the selected coefficient to a quantizer (14). A quantization coefficient (D14) generated by the quantizer (14) is encoded at a downstream stage and supplied to a dequantizer (15) as well. The dequantizer (15) dequantizes the supplied quantization coefficient (D14) taking the number of bit planes (D18) truncated by a rate controller (22) in consideration. The image encoder (10) further includes an adder (16) which adds a wavelet transform coefficient (D15) resulted from the dequantization and wavelet transform coefficient (D16) of the preceding frame to update the content of the memory (17). Thus, a plurality of frames forming together a moving picture is sequentially compressed by coding with the use of a correlation between the frames.

### RELATED APPLICATION DATA

The present application claims priority to Japanese application No. P2004-037390 filed Feb. 13, 2004, which application is incorporated herein by reference to the extent permitted by law.

### BACKGROUND OF THE INVENTION

1. Field of the Invention

The present invention relates to an image coding apparatus and method, for sequentially compressing, by coding with the JPEG 2000 technique, for example, a plurality of frames forming together a moving picture into an encoded code stream, and an image decoding apparatus and method, for reconstructing the moving picture by decoding the encoded code stream with the same technique.

This application claims the priority of the Japanese Patent Application No. 2004-037390 filed on Feb. 13, 2004, the entirety of which is incorporated by reference herein.

2. Description of the Related Art

As a typical one of the conventional image compressing techniques, there is available the JPEG (Joint Photographic Experts Group) standardized by the ISO (International Standards Organization), in which the discrete cosine transform (DCT) is used. The JPEG 2000 technique is known for the capability of assuring a high quality of coded image and decoded image by allocating a relatively large number of bits. In case the number of coded bits is smaller than a certain one, however, the block distortion peculiar to the DCT will be considerable and images be noticeably lower in quality from a subjective point of view.

On the other hand, it has recently been proposed to break an image into a plurality of frequency bands by a combination of a low-pass filter and high-pass filter, called “filter bank”, and then encode each frequency band, and more and more researches have been done for such coding techniques. Of these techniques, the wavelet transform coding is considered as a promising technique which may replace DCT because the block will not remarkably be distorted with a high degree of compression as in DCT. The JPEG 2000 technique internationally standardized by the ISO in January, 2001 adopts a combination of the wavelet transform, quantization and high-efficiency entropy coding (bit modeling and arithmetic coding in units of a bit plane), and implements a considerably improved efficiency of coding in comparison with the conventional JPEG technique.

Further, the ISO standardized the Motion-JPEG 2000 technique for the moving picture coding and file format as a Part-3 standard which is an extension version of the JEPG 2000 in January, 2002. Also, the Inventors of the present invention proposed a technique for encoding a moving picture efficiently with the Motion-JPEG 2000 technique (as disclosed in the Japanese Patent Application Laid Open No. 2001-197499).

The above-mentioned JPEG 2000 technique is a standard for the moving picture coding. It makes an intra-frame coding of each of frames forming together a moving picture but does not make any coding of a frame on the basis of a relation with frames preceding and following the frame in consideration and a field as in the MPEG (Moving Picture Experts Group). Thus, the Motion-JPEG 2000 technique is lower in efficiency of compression in moving picture coding than the MPEG.

### OBJECT AND SUMMARY OF THE INVENTION

It is therefore an object of the present invention to overcome the above-mentioned drawbacks of the related art by providing an image coding apparatus and method, for sequentially compressing, by coding with the JPEG 2000 technique, for example, a plurality of frames forming together a moving picture into an encoded code stream by using the correlation between the frames, and an image decoding apparatus and method, for reconstructing the moving picture by decoding the encoded code stream with the same technique.

The above object can be attained by providing an image coding apparatus and method, in which a wavelet transform coefficient is generated by making wavelet transform of an input frame being one of a plurality of frames forming together a moving picture, a difference is calculated between the wavelet transform coefficient of the input frame and a wavelet transform coefficient of a preceding frame stored in a memory to generate a wavelet transform coefficient of a difference frame resulted from the calculation, and either the wavelet transform coefficient of the input frame or that of the difference frame is quantized to generate a quantization coefficient. Then, the quantization coefficient is dequantized to generate a wavelength transform coefficient, the dequantized wavelet transform coefficient and that of the preceding frame stored in the memory are added together, and wavelet transform coefficient of the preceding frame stored in the memory is updated by the sum of the wavelet transform coefficients. Also, the quantization coefficient is broken into a plurality of code blocks each having a predetermined size, the quantization coefficient of each of the code blocks is developed in a plurality of planes of bits ranging from the most significant bit to least significant bit, bit modeling is made of each bit plane to generate a coding pass, the coding pass thus generated is arithmetically coded, and the arithmetic code thus generated is formatted to generate an encoded code stream.

In the above image coding apparatus and method, when coding each of frames forming together a moving picture, comparison is made between the absolute value sum of the wavelet transform coefficients of the input frame, for example, over the frame and sum of the wavelet transform coefficients of the difference frame, and either intra- or inter-frame coding is selected for each of the frames.

Also, the object can be attained by providing an image coding apparatus and method, in which a wavelet transform coefficient is generated by making wavelet transform of an input frame being one of a plurality of frames forming together a moving picture, the wavelet transform coefficient is broken into a plurality of code blocks each having a predetermined size, a difference is calculated between the wavelet transform coefficient of each code block of the input frame and a wavelet transform coefficient of a code block in the corresponding position in a preceding frame stored in a memory at every code block to generate a wavelet transform coefficient of a difference frame resulted from the calculation, and either the wavelet transform coefficient of the input frame or that of the difference frame is quantized to generate a quantization coefficient of each code block. Then, the quantization coefficient is dequantized to generate a wavelength transform coefficient, the dequantized wavelet transform coefficient and that of the preceding frame stored in the memory are added together, and wavelet transform coefficient of the preceding frame stored in the memory is updated by the sum of the wavelet transform coefficients. Also, the quantization coefficient of each of the code blocks is developed in a plurality of planes of bits ranging from the most significant bit to least significant bit, bit modeling is made of each bit plane to generate a coding pass, the coding pass thus generated is arithmetically coded, and the arithmetic code thus generated is formatted to generate an encoded code stream.

In the above image coding apparatus and method, when coding each of frames forming together a moving picture, comparison is made between the absolute value sum of the wavelet transform coefficients of the input frame, for example, over the code block and sum of the wavelet transform coefficients of the difference frame over the code block, and either intra- or inter-frame coding is selected for each of the code blocks.

Also the above object can be attained by providing an image coding apparatus and method, in which a wavelet transform coefficient is generated by making wavelet transform of an input frame being one of a plurality of frames forming together a moving picture, the wavelet transform coefficient is quantized to generate a quantization coefficient, the quantization coefficient is broken into a plurality of code blocks each having a predetermined size, a difference is calculated between the quantization coefficient of each code block of the input frame and that in each code block in the corresponding position in a preceding frame stored in a memory to generate a quantization coefficient of a difference frame resulted from the calculation for each of the code blocks, and either the quantization coefficient of the input frame or that of the difference frame is selected for each of the code blocks. Then, the quantization coefficient of the input frame or that of the difference frame and the quantization coefficient of the preceding frame stored in the memory are added together, and the quantization coefficient of the preceding frame stored in the memory is updated by the sum of the quantization coefficients. Also, the quantization coefficient of each of the code blocks is developed in a plurality of planes of bits ranging from the most significant bit to least significant bit, bit modeling is made of each bit plane to generate a coding pass, the coding pass thus generated is arithmetically coded, and the arithmetic code thus generated is formatted to generate an encoded code stream.

In the above image coding apparatus and method, when coding each of frames forming together a moving picture, comparison is made between the absolute value sum of the quantization coefficients in each code block of the input frame, for example, over the code block and absolute value sum of the quantization coefficients in each code block of the difference frame over the code block, and either intra- or inter-frame coding is selected for each of the code blocks.

Also the above object can be attained by providing an image decoding apparatus and method, for generating a decoded image by decoding an encoded code stream generated by the above-mentioned image coding apparatus and method, wherein the encoded code stream is decoded based on a predetermined parameter indicating which has been made of each frame or code block, intra- or inter-frame coding.

Since the above image decoding apparatus and method according to the present invention can select inter-frame coding of each frame other than a top frame forming a moving picture in each frame or code block, the compression can be made with an improved efficiency in comparison with the compression by only the intra-frame coding. Especially, since it suffices to make only the difference calculation even in the inter-frame coding, a higher speed of coding can be attained than with the MPEG technique.

Also, with the image decoding apparatus and method according to the present invention, a coded image can be decoded by decoding each frame or code block of the image on the basis of a predetermined parameter indicating which has been made of the frame or code block, intra- or inter-frame coding.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 is a schematic block diagram of an image encoder according to the first embodiment of the present invention;

FIG. 2 explains subbands resulted from three times of wavelet transform;

FIGS. 3A and 3B explain subbands results from wavelet transform of an actual image;

FIG. 4 explains the relation between code blocks and subbands;

FIG. 5 explains a bit plane, in which FIG. 5A shows a quantization coefficient including a total of 16 coefficients, FIG. 5B shows absolute-value bit planes of the coefficients, and FIG. 5C shows a code bit plane;

FIG. 6 explains processing of a coding pass in a code block;

FIG. 7 explains a sequence of scanning coefficients in a code block;

FIG. 8 explains significant and non-significant coefficient bits;

FIG. 9 shows an example in which a frame to undergo intra-frame coding at every 15 frames;

FIG. 10 is a schematic block diagram of an image encoder according to the second embodiment of the present invention;

FIG. 11 is also a schematic block diagram of an image encoder according to the third embodiment of the present invention;

FIG. 12 is a schematic block diagram of the selector provided in the image encoder to select the intra- or inter-frame coding depending upon the number of significant coefficients in each bit plane;

FIG. 13 is a schematic block diagram of an image decoder according to the fourth embodiment of the present invention;

FIG. 14 is also a schematic block diagram of an image decoder according to the fifth embodiment of the present invention; and

FIG. 15 is a schematic block diagram of an image decoder according to the sixth embodiment of the present invention.

### DETAILED DESCRIPTION OF THE PREFERRED EMBODIMENTS

The present invention will be described in detail below concerning the embodiments thereof with reference to the accompanying drawings. The embodiments are applications of the present invention to an image coding apparatus and method, for sequentially compressing, by coding with the JPEG 2000 technique, for example, a plurality of frames forming together a moving picture into an encoded code stream by using the correlation between the frames, and to an image decoding apparatus and method, for reconstructing the moving picture by decoding the encoded code stream with the same technique.

### (1) First Embodiment

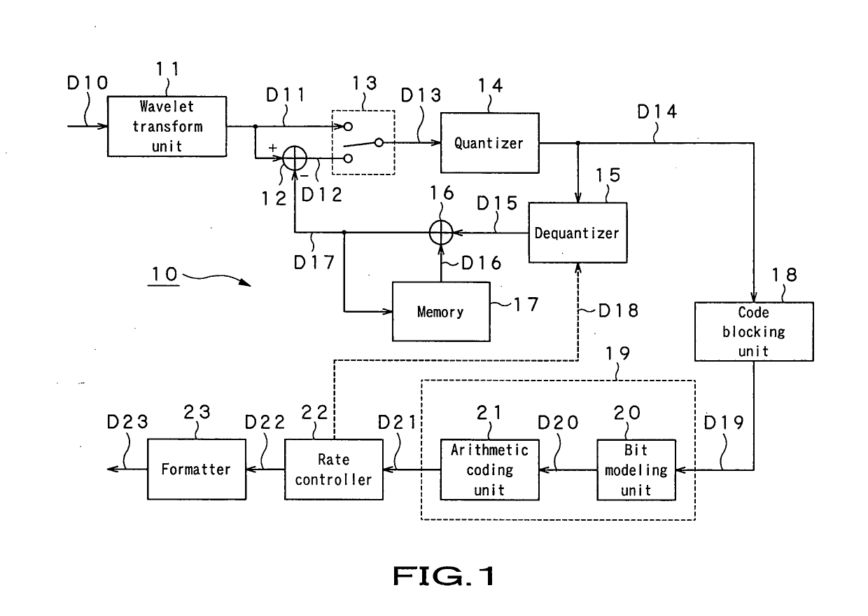

Referring now to FIG. 1, an image encoder according to the first embodiment is schematically illustrated in the form of a block diagram. As shown in FIG. 1, the image encoder, generally indicated with a reference numeral 10, includes a wavelet transform unit 11, difference calculator 12, selector 13, quantizer 14, dequantizer 15, adder 16, memory 17, code blocking unit 18, bit modeling unit 20, arithmetic coding unit 21, rate controller 22, and a formatter 23. It should be noted here that the bit modeling unit 20 and arithmetic coding unit 21 form together an EBCOT (embedded coding with optimized truncation) unit 19.

The wavelet transform unit 11 is normally a filter bank that is a combination of a low-pass filter and high-pass filters. It should be noted that since a digital filter has an impulse response (filter factor) which is normally a plurality of taps in length, it is necessary to pre-buffer a sufficient input image for filtering. However, the pre-buffering is so simple that it is not shown in FIG. 1.

The wavelet transform unit 11 generates a wavelet transform coefficient D11 by making wavelet transform of a minimum necessary image signal D10 for filtering and filtering the wavelet-transformed image signal D10, and supplies the wavelet transform coefficient D11 thus generated to the difference calculator 12 and selector 13.

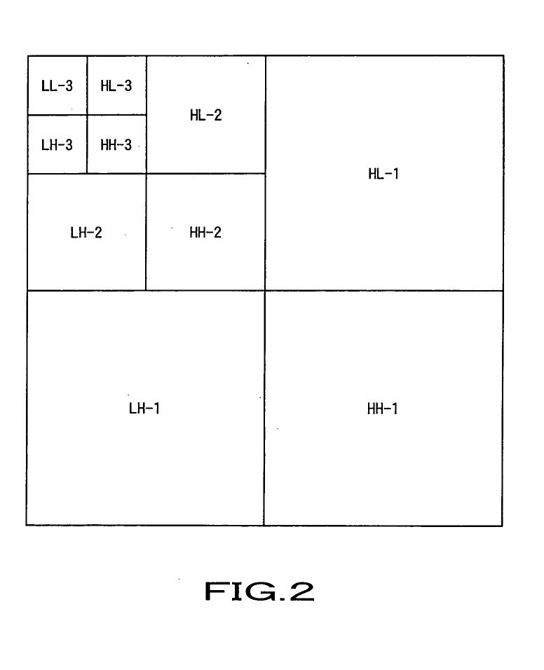

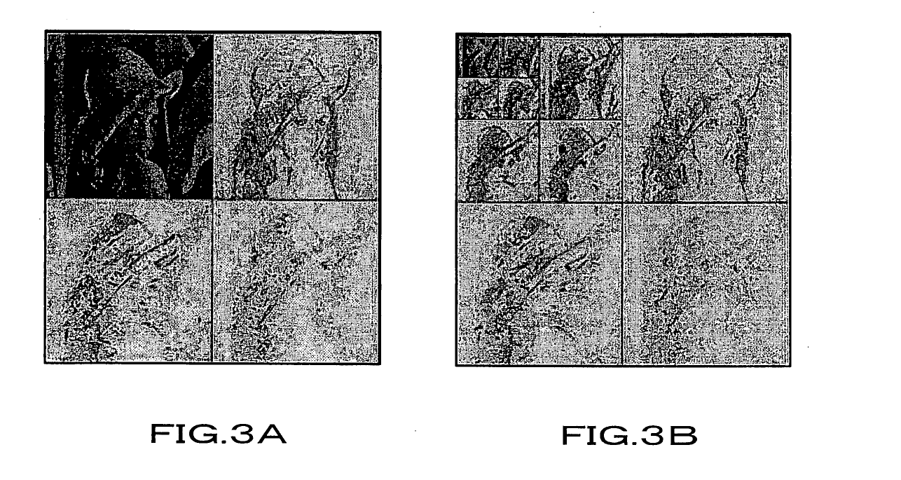

Normally in the wavelet transform, a low-frequency component is iteratively transformed as shown in FIG. 2 because the low-frequency component shares most of the image energy, which will be known from FIG. 3A showing subbands formed as the division level exceeds from “1” as in FIG. 3A to “3” as in FIG. 3B. The division level of the wavelet transform in FIG. 2 is “3”, resulting in 10 subbands. It should be noted that “L” and “H” in FIG. 2 indicate low- and high-frequency bands, respectively and numerals next to “L” and “H” indicate division levels, respectively. For example, “LH-1” indicates a subband whose frequency goes lower in the horizontal direction and higher in the vertical direction which has a division level “1”.

The difference calculator 12 subtracts a wavelet transform coefficient D17 supplied from the memory 17 which will be described in detail later from the wavelet transform coefficient D11, and supplies the selector 13 with a difference coefficient D12 resulted from the subtraction.

The selector 13 selects either the wavelet transform coefficient D11 supplied from the wavelet transform unit 11 or the difference coefficient D12 supplied from the difference calculator 12, and supplies a wavelet transform coefficient or difference coefficient D13 to the quantizer 14. More specifically, the selector 13 calculates an absolute value sum of wavelet transform coefficients D11 over the frame and an absolute value sum of difference coefficients D12 over the frame, and selects one of the wavelet transform and difference coefficients D11 and D12, whichever is smaller in absolute value sum.

The quantizer 14 makes irreversible compression of the wavelet transform coefficient or difference coefficient D13 supplied from the selector 13, and supplies a quantization coefficient D14 to the dequantizer 15 and code blocking unit 18. The quantizer 14 may adopt a scalar quantization in which the wavelet transform coefficient or difference coefficient D 13 is divided by a quantization-step size.

Note here that the quantization-step size A is given by the following equation (1) as the E.3 equation defined in the JPEG 2000 standard:
Δ_{b}=2^{Rb-εb}(1+μ_{b}/2¹¹) (1)
where Δ_{b} is a quantization-step size assigned to a subband b, R_{b} is a dynamic range assigned to the subband b, ε_{b} is a quantization exponent assigned to the subband b and μ_{b} is a quantization mantissa assigned to the subband b.

The quantizer 14 uses the quantization-step size Δ_{b} determined based on the above equation (1) to calculate a quantization coefficient q_{b}(u, v) given by the following equation (2):
q_{b}(u,v)=sign(dwt_{b}(u,v))×floor(|dwt_{b}(u,v)|/Δ_{b}) (2)
where dwt_{b}(u, v) is a wavelet transform coefficient in a coordinate position (u, v), sign(x) is x when x is positive and −x when x is negative, and floor(x) indicates a truncation of x to an integer (for example, floor(2, 5)=2).

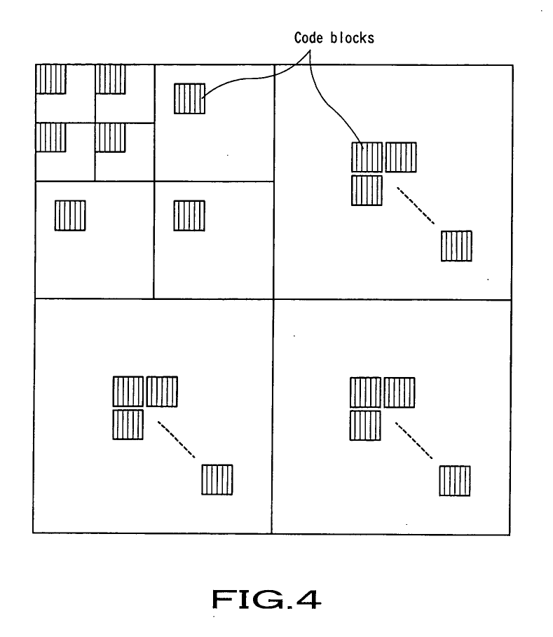

The code blocking unit 18 breaks a quantization coefficient D14 supplied from the quantizer 14 into code blocks each having a predetermined size and used as a unit for entropy coding. FIG. 4 shows the geometry of code blocks in the subbands. Normally, code blocks each having a size of about 64×64, for example, are generated in all the subbands. Therefore, in a subband of 640×320 in size, there will exist a total of 50 code blocks each having a size of 64×64 (10 in the horizontal direction and 5 in the vertical direction). The code blocking unit 18 supplies a quantization coefficient D19 in each code block to the EBCOT unit 19, and coding will be done per code block in the subsequent stage.

The EBCOT unit 19 develops the quantization coefficient D19 in each code block in a bit plane, and makes bit modeling and arithmetic coding in units of a bit plane. It should be noted that EBCOT is described in detail in the document “ISO/IEC 15444-1, Information Technology-JPEG 2000, Part 1: Code Coding System”.

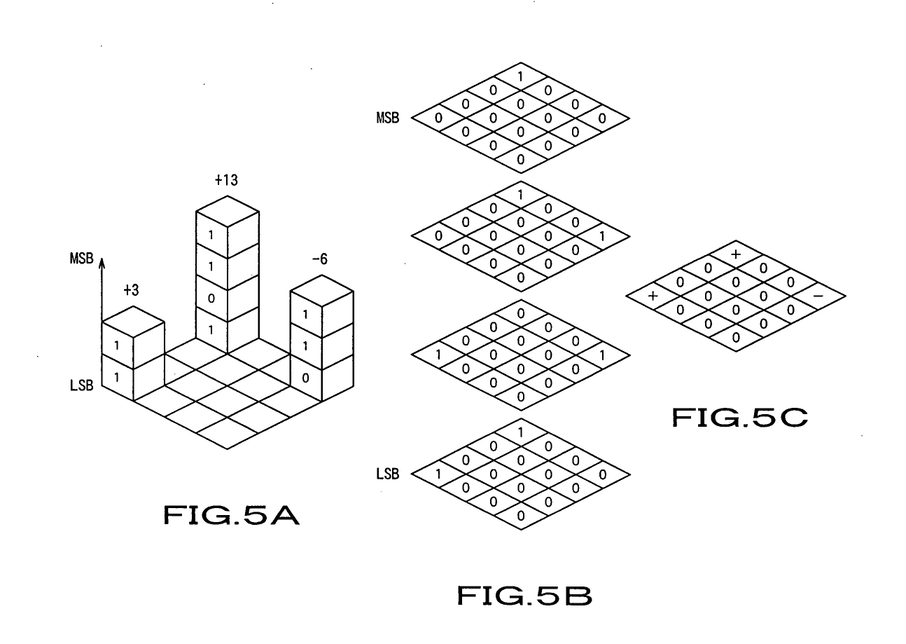

Prior to describing EBCOT, the concept of the bit plane will be explained below with reference to FIG. 5. In FIG. 5A, there is assumed a quantization coefficient including a total of 16 coefficients (4 in the vertical direction and 4 in the horizontal direction). The largest one of the absolute values of the 16 quantization coefficients is “13”, which is “1101” in the binary notation. Therefore, the bit planes of the absolute values of the coefficients include four bit planes as shown in FIG. 5B. It should be noted that each of coefficient bits in each bit plane takes a value “0” or “1”. The quantization coefficients take “0” or a positive value except for the quantization coefficient taking a negative value “−6”. Therefore, the bit plane of codes is as shown in FIG. 5C.

Note here that EBCOT is a means for encoding coefficient bits in each of a block having a predetermined size while measuring the statistic of the coefficient bits. It permits to make entropy coding of quantization coefficients in units of the code block. The code blocks are encoded independently of each other in a direction from the most significant bit (MSB) toward least significant bit (LSB) in each bit plane. Also, each of the vertical and horizontal sizes of the code block is a power of 2 (two) in a range from 4 to 256, and 32×32, 64×64, 128×32, etc. are normally used as a code block size. A quantization coefficient is represented by a signed n-bit binary number, and bits 0 to (n−2) represent bits ranging from the least significant bit (LSB) to most significant bit (MSB), respectively. It should be noted that the remaining one bit is a sign. The code blocks are encoded sequentially starting with the plane of the most significant bits (MSB) along the following three types of coding passes (a) to (c):
(a) Significance propagation pass
(b) Magnitude refinement pass
(c) Cleanup pass

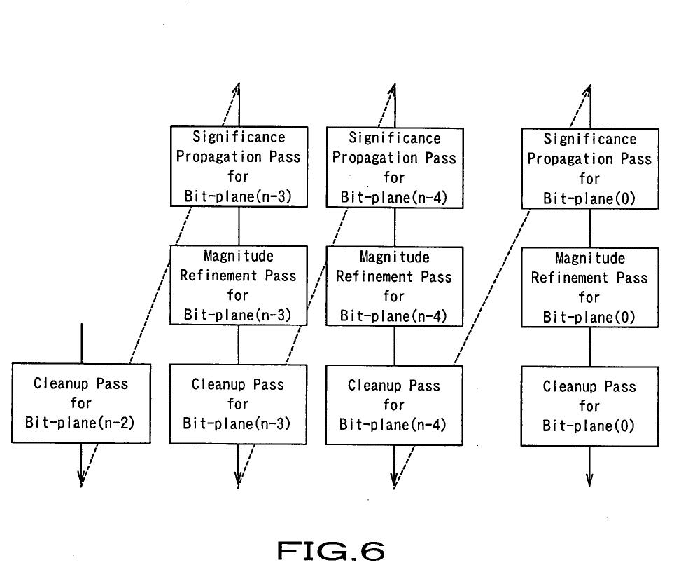

The sequence in which the above three coding passes are used is shown in FIG. 6. As shown in FIG. 6, the bit plane (n−2) (MSB) is first encoded along the Cleanup pass (will be referred to as “CU pass” wherever appropriate hereunder). Next, each bit plane is encoded sequentially along the Significance propagation pass (will be referred to as “SP pass” wherever appropriate hereunder), Magnitude refinement pass (will be referred to as “MR pass” wherever appropriate hereunder) and CU pass in this order toward the least significant bit (LSB).

Actually, however, the how-manieth bit plane from the most significant bit (MSB) plane in which “1” will first appear is written in the header and any bit plane including only zero coefficients (zero-bit plane) will not be encoded. In EBCOT, the bit plane is encoded by using these three types of coding passes iteratively in the above order.

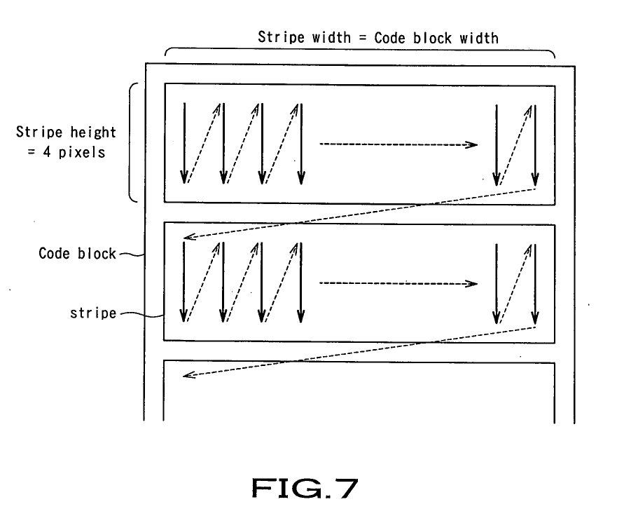

The coefficient bits are scanned as will be explained herebelow with reference to FIG. 7. A code block is broken into stripes at every four vertical coefficient bits. Each of the stripe is as wide as the code block. Scanning sequence is a sequence in which all the coefficient bits in one code block are scanned. The coefficient bits will be scanned in a sequence from an upper to lower stripe in a code block, in a sequence from a left to right row in each stripe and in a sequence from top to bottom in each row. It should be noted that all coefficient bits in a code block are scanned in the above scanning sequence along each of the coding passes.

Each of the three types of coding passes will be explained herebelow. It should be noted that all these three types of coding passes are described in the aforementioned document “ISO/IEC 15444-1, Information Technology-JPEG 2000, Part 1: Core Coding System”.

(a) Significance Propagation Pass (SP Pass)

Along the SP pass to encode a bit plane, non-significant coefficient bits in which at least one coefficient bit near “8” is significant will be arithmetically encoded. In case the encoded coefficient bit has a value “1”, the code sign (positive or negative) is arithmetically encoded next to the coefficient bit itself.

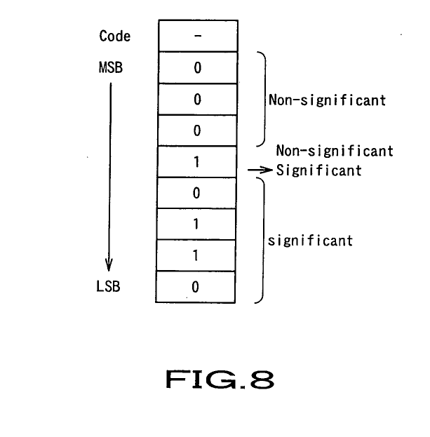

The term “significance” means a state the encoder has for each coefficient bit. The initial value of the “significance” is “0”. When “1” is encoded as a coefficient bit, the “significance” will have the value thereof changed to “1” which means the coefficient bit is “significant” and will continuously have the value “1” thereafter. For example, in case “00010110” which is a binary notation of a quantization coefficient “−22” is to be encoded as shown in FIG. 8, the coding begins with the plane of the most significant bits (MSB). Since the coefficient bits are all “0” in value down to the third bit plane from the most significant bit (MSB), they are continuously “non-significant”. However, when the fourth bit plane whose coefficient bit has a value “1” is encoded, the coefficient bit state will change from “non-significant” to “significant”. Subsequently, the coefficient bit state will continuously be “significant” whether the coefficient bits are “0” or “1” in value. Therefore, the “significance” may be a flag indicative of whether information at effective digits have already been encoded or not. If the SP pass takes place in a bit plane, no SP pass will occur in the subsequent plane planes.

(b) Magnitude Refinement Pass (MR Pass)

Along the MR pass to encode a bit plane, there will be arithmetically encoded significant coefficient bits having not been encoded along the SP pass which should have encoded the bit plane.

(c) Cleanup Pass (CU Pass)

Along the CU pass to encode a bit plane, there will be arithmetically encoded non-significant coefficient bits having not been encoded along the SP pass which should have encoded the bit plane. When the coefficient bit thus encoded has a value “1”, the code sign (positive or negative) is arithmetically encoded next to the coefficient bit itself.

Note that the arithmetic coding effected along the aforementioned three types of coding passes includes ZC (zero coding), RLC (run-length coding), SC (sign coding) and MR (magnitude refinement) which are selectively used case by case to select a context for a coefficient. Then a symbol for a coefficient bit and selected context are encoded with an arithmetic code (which is called “MQ coding”). The MQ coding is a learning-type binary arithmetic coding defined in JBIG2. The MQ coding is described in the document “ISO/IEC FDIS 14492, Lossy/Lossless Coding of Bi-level Images, March 2000” etc. In the JPEG 2000 standard, a total of 19 types of contexts is defined for all the coding passes.

As above, the bit modeling unit 20 develops the quantization coefficient D19 in each code block in a bit plane and processes the coefficient bits in each bit plane along the three types of coding passes to generate a symbol and context D20 for each of the coefficient bits. The arithmetic coding unit 21 makes arithmetic coding of the symbol and context D20 for each coefficient, and supplies the rate controller 22 with an arithmetic code D21 resulted from the arithmetic coding.

The rate controller 22 controls the rate by truncating unnecessary bit planes from the least significant bit (LSB) planes or selecting bit planes from the most significant bit (MSB) planes and truncating bit planes which are eventually unnecessary, so that the entire code amount will be a target one and the quality of a reconstructed image be optimum, and supplies the formatter 23 with an arithmetic code string D22 whose rate has been controlled. Also, the rate controller 22 supplies the dequantizer 15 with the number of truncated bit planes D18 at each code block.

The formatter 23 adds various headers to the arithmetic code string D22 supplied from the rate controller 22, formats the arithmetic code string for compliance with the JPEG 2000 standard, and then supplies the formatted arithmetic code string as an encoded code stream D23 to outside.

The dequantizer 15 dequantizes the quantization coefficient D14 supplied from the quantizer 14 to generate a wavelet transform coefficient D15, and supplies the wavelet transform coefficient D15 to the adder 16. At this time, the rate controller 22 will truncate the unnecessary bit planes from the least significant bit (LSB) bit planes. Truncation of T_{c} bit planes in a code block is equal to dividing of the quantization coefficients in the code block by 2^{Tc}. That is, the quantization step size Δ_{c} as a result of the rate control is given by the following equation (3):
Δ_{c}=Δ_{b}×2^{Tc} (3)

Thus the dequantizer 15 should operate reflecting the result of the rate control. More particularly, the dequantizer 15 generates a dequantized wavelet transform coefficient D15 using the number of truncated bit planes D18 at each code block, supplied from the rate controller 22, on the basis of the following equation (4) given as the equation E. 6 in the JPEG 2000 standard:

$$Rq ( u , v ) = \{ \begin{matrix}( q ( u , v ) + r \cdot {2}^{Tc} ) \cdot {Δ}_{b} & for & q ( u , v ) > 0 \\ ( q ( u , v ) - r \cdot {2}^{Tc} ) \cdot {Δ}_{b} & for & q ( u , v ) < 0 \\ 0 & for & q ( u , v ) = 0\end{matrix} \qquad ( 4 )$$

where Rqb(u, v) indicates a dequantized wavelet transform coefficient and r indicates a dequantization parameter.

The adder 16 adds the wavelet transform coefficient D 15 supplied from the dequantizer 15 and the wavelet transform coefficient D 16 of a preceding frame stored in the memory 17, and supplies the difference calculator 12 with a wavelet transform coefficient D17 resulted from the addition. Also, the adder 16 supplies the wavelet transform coefficient D17 to the memory 17 as well to write it over the existent wavelet transform coefficient in the memory 17. The content of the memory 17 is thus updated. As far as a leading frame is concerned, however, since the memory 17 stores nothing, the dequantized wavelet transform coefficient D15 will be written as it is into the memory 17.

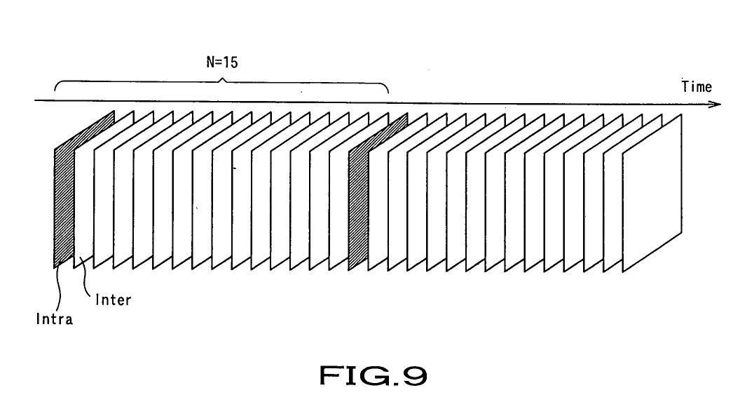

When sequentially supplied with a plurality of frames forming together a moving picture as above, the image encoder 10 will always make intra-frame coding of a leading one of the frames while making inter-frame coding of subsequent frames. To prevent diffusion of any quantization or dequantization error, however, a frame that is to undergo intra-frame coding should preferably be provided at every N frames (15 frames, for example) as shown in FIG. 9.

Note that to supply the image decoder with selection information on whether the intra-frame coding or inter-frame coding has been done, the selection information has to be included in the encoded code stream D23. To this end, the formatter 23 describes selection information in a comment marker (COM) which is a general-purpose marker code in the JPEG 2000 standard.

Since the image encoder 10 according to the first embodiment of the present invention can select the inter-frame coding for each of other frames than a leading one in a moving picture, the compression can be done with a higher efficiency than in case only the intra-frame coding is done. Especially, in this image encoder 10, since only the difference calculation is done without any motion prediction as with the MPEG (Moving Picture Experts Group) technique, coding can be done at a higher speed than with the MPEG technique.

Also, since the above is in compliance with the JPEG 2000 Part-1 standard, even a conventional image decoder, not an image decoder corresponding to the image encoder 10, can provide a decoded image having a minimum necessary quality.

### (2) Second Embodiment

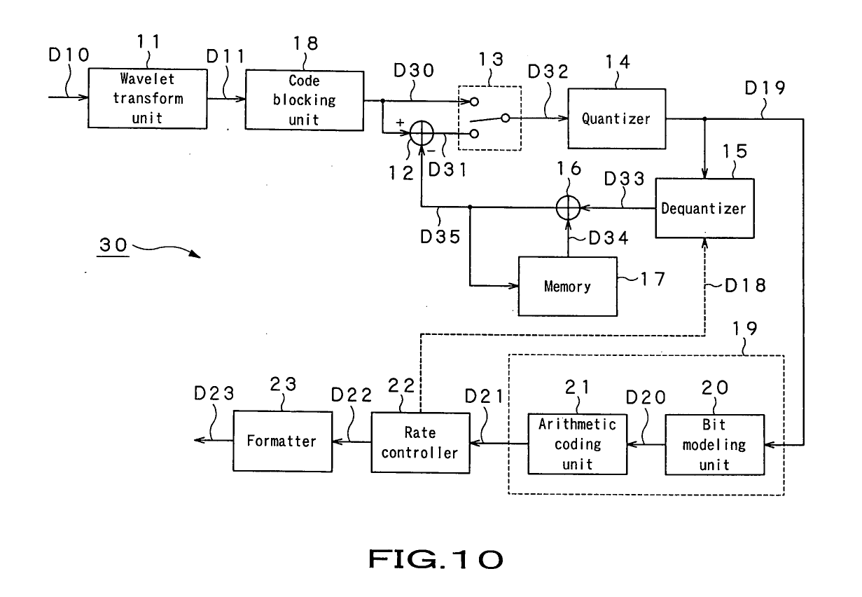

Referring now to FIG. 10, there is schematically illustrated in the form of a block diagram an image encoder according to the second embodiment of the present. The image encoder is generally indicated with a reference numeral 30. This image encoder 30 is basically configured similarly to the image encoder 10 shown in FIG. 1 except for a code blocking unit 18 disposed immediately after the wavelet transform unit 11 and selection of either the intra-coding or inter-frame coding for each code block. Therefore, the same or similar components of the image encoder 30 as or to those in the image encoder 10 as in FIG. 1 will be indicated with the same reference numerals as in the image encoder 10 and will not be described in detail any longer.

In the image encoder 30, the code blocking unit 18 breaks a wavelet transform coefficient D11 supplied from the wavelet transform unit 11 into code blocks, and supplies a wavelet transform coefficient D30 in each code block to the difference calculator 12 and selector 13.

The difference calculator 12 subtracts a wavelet transform coefficient D35 supplied from the memory 17 from the wavelet transform coefficient D30, and supplies the selector 13 with a difference coefficient D31 resulted from the subtraction. It should be noted that the wavelet transform coefficient D35 is a coefficient of a code block in the same position as that of the wavelet transform coefficient D30 supplied from the code blocking unit 18.

The selector 13 selects either the wavelet transform coefficient D30 supplied from the wavelet transform unit 11 or the difference coefficient D31 supplied from the difference calculator 12, and supplies the selected wavelet transform coefficient or difference coefficient D31 to the quantizer 14. More specifically, the selector 13 calculates an absolute value sum of wavelet transform coefficients D30 over the code block and an absolute value sum of difference coefficients D31 over the code block, and selects one of the coefficients, whichever is smaller in absolute value sum.

The quantizer 14 makes irreversible compression of the wavelet transform coefficient or difference coefficient D32 supplied from the selector 13, and supplies a quantization coefficient D19 to the dequantizer 15 and code blocking unit 18.

The dequantizer 15 generates a dequantized wavelet transform coefficient D33 using the number of truncated bit planes D18 in each code block, supplied from the rate controller 22 as having previously been described.

The adder 16 adds the wavelet transform coefficient D33 supplied from the dequantizer 15 and the wavelet transform coefficient D34 of a preceding frame stored in the memory 17, and supplies the difference calculator 12 with a wavelet transform coefficient D35 resulted from the addition. Also, the adder 16 supplies the wavelet transform coefficient D35 to the memory 17 as well to write it over the existent wavelet transform coefficient in the memory 17. The content of the memory 17 is thus updated.

Since the image encoder 30 according to the second embodiment of the present invention can select the inter-frame coding not for each frame but for each code block as above, the data processing will be more complicated than in the processing of each frame, but the compression can be done with a higher efficiency and the quality of an image thus decoded is higher.

### (3) Third Embodiment

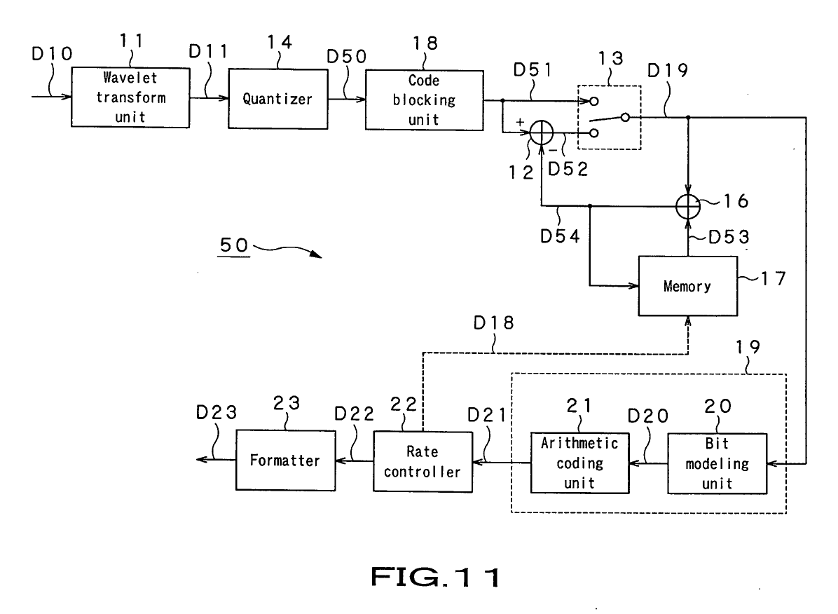

Referring now to FIG. 11, there is schematically illustrated in the form of a block diagram an image encoder according to the third embodiment of the present invention. The image encoder is generally indicated with a reference numeral 50. As shown in FIG. 11, this image encoder 50 is basically configured similarly to the image encoders 10 and 30 shown in FIGS. 1 and 10, respectively, except for a quantizer 14 disposed immediately after the wavelet transform unit 11 and calculation of a difference between the quantization coefficients. Therefore, the same or similar components of the image encoder 50 as or to those in the image encoders 10 and 30 as in FIGS. 1 and 10, respectively, will be indicated with the same reference numerals as in the image encoders 10 and 30 and will not be described in detail any longer.

In the image encoder 50, the quantizer 14 makes irreversible compression of the wavelet transform coefficient D11 supplied from the wavelet transform unit 11, and supplies a quantization coefficient D50 to the code blocking unit 18.

The code blocking unit 18 breaks the quantization coefficient D50 supplied from the quantizer 14 into code blocks, and supplies a quantization coefficient D51 in each code block to the difference calculator 12 and selector 13.

The difference calculator 12 subtracts a wavelet transform coefficient D54 supplied from the memory 17 from the quantization coefficient D51, and supplies the selector 13 with a difference coefficient D52 resulted from the subtraction. It should be noted that the wavelet transform coefficient D54 is a coefficient of a code block in the same position as that of the wavelet transform coefficient D51 supplied from the code blocking unit 18.

The selector 13 selects either the quantization coefficient D51 supplied from the code blocking unit 18 or difference coefficient D52 supplied from the difference calculator 12, and supplies the selected quantization coefficient or difference coefficient D19 to the EBCOT unit 19. More specifically, the selector 13 calculates an absolute value sum of quantization coefficients D51 over the code block and an absolute value sum of difference coefficients D52 over the code block, and selects one of the quantization and difference coefficients D51 and D52, which is smaller in absolute value sum.

The adder 16 adds the quantization coefficient D15 in each code block, supplied from the selector 13 or difference coefficient D19 and the quantization coefficient D53 in a code block in the same position as that of a preceding frame stored in the memory 17, and supplies the difference calculator 12 with a quantization coefficient D54 resulted from the addition. Also, the adder 16 supplies the quantization coefficient D54 to the memory 17 as well to write it over the existent quantization coefficient in the memory 17. The content of the memory 17 is thus updated.

Also in the image encoder 50, the quantizer 14 should operate reflecting the result of rate control as having previously been described. To this end, the rate controller 22 supplies the memory 17 with a number of truncated bit planes D18 in each code block. Using the number of truncated bit planes D18 supplied from the rate controller 22, the memory 17 determines a quantization step size Δ_{c} as the result of rate control as given by the aforementioned equation (3), and corrects the quantization coefficients stored therein by the quantization step size Δ_{c}. The aforementioned adder 16 adds the corrected quantization coefficient D53 and the quantization coefficient or difference coefficient D19.

In the image encoder 50 according to the third embodiment, the quantization coefficient is stored in the memory 17, not the wavelet transform coefficient as in the first and second embodiments. Since the bit accuracy may be lower for the quantization coefficient than for the wavelet transform coefficient, the image encoder 50 may be smaller in scale when it is implemented in the form of a hardware or software.

Note that the present invention is not limited to the aforementioned calculation by the selector 13 of an absolute value sum of quantization coefficients D51 over a code block and absolute value sum of difference coefficients D52 over the code block to select one of the quantization and difference coefficients D51 and D52, whichever is smaller in absolute value sum, as in the foregoing.

For example, the number of effective bit planes in each code block of the quantization coefficient D51 and number of effective bit planes in each code block of the difference coefficient D52 may be calculated to select one of the quantization and difference coefficients D51 and D52, whichever is smaller in number of effective bit planes. It should be noted that the “effective bit plane” means bit planes in each code block, from which ones not to be encoded and ones to be truncated by the rate controller 22, that is, bit planes which will be included in the final encoded code stream D23.

In this case, it is necessary to develop the quantization coefficients D51 or difference coefficients D52 in a bit plane at a stage upstream of the bit modeling unit 20. However, since the number of effective bit planes has a close relationship with the amount of generated codes, it is possible to select the intra- or inter-frame coding with a high accuracy, and thus to limit the amount of generated codes.

Also, concerning the bit plane of each code block of the quantization coefficient D51 and bit plane of each code block of the difference coefficient D52, the number of coefficient bits which become first significant in each bit plane, that is, coefficient bits whose value is “1” in the bit plane and “0” in more-significant bit planes, may be subjected to weighted addition to select one of the coefficients D51 and D52, whichever is smaller in result of the addition.

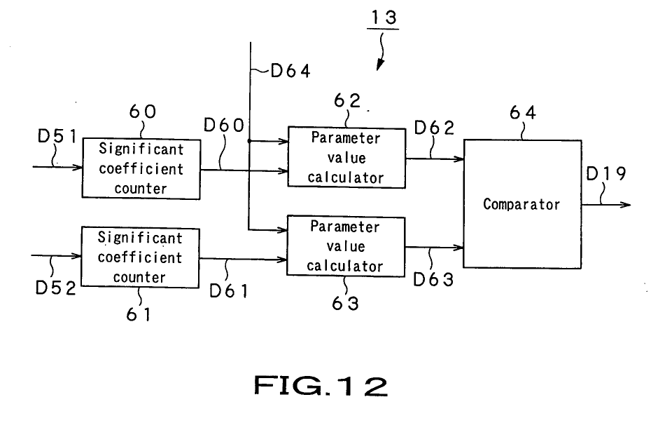

More particularly, the significant coefficient counters 60 and 61 calculate the numbers of coefficient bits which become significant for the first time in the bit planes of the quantization coefficient D51 and difference coefficient D52, and supply significant coefficient counts D60 and D61 to the parameter value calculators 62 and 63, respectively, as shown in FIG. 12. The parameter value calculators 62 and 63 supplies the comparator 64 with values D62 and D63 resulted from multiplication of the significant coefficient counts D60 and D61 by a predetermined parameter D64. The comparator 64 outputs either the value D62 or D63, whichever is smaller.

In this case, it is necessary to develop the quantization coefficient D51 or difference coefficient D52 in a bit plane and make bit modeling. Thus, it is possible to make a decision for selection of either the intra- or inter-frame coding with a higher accuracy, and thus to limit the amount of generated codes.

### (4) Fourth Embodiment

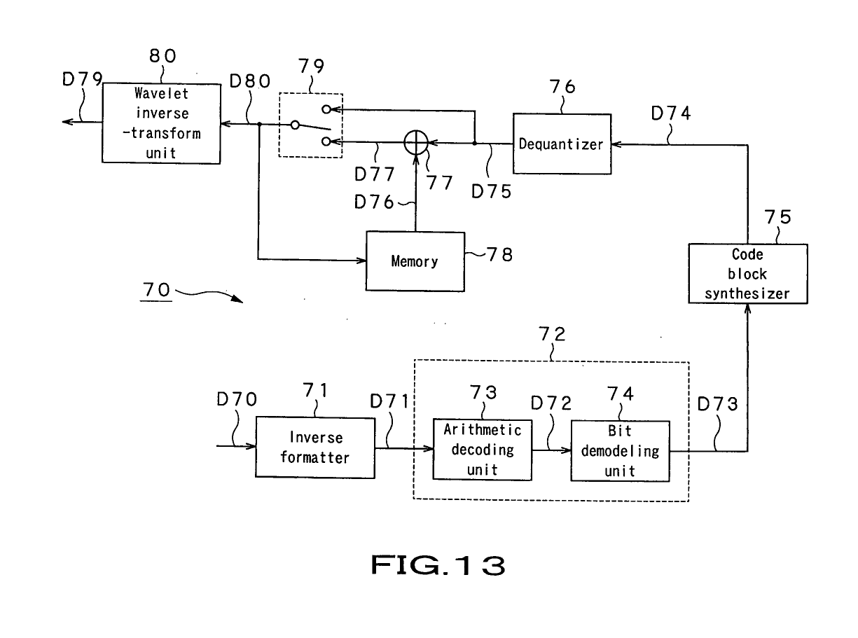

Referring now to FIG. 13, there is schematically illustrated in the form of a block diagram an image decoder according to the fourth embodiment of the present invention. The image decoder is generally indicated with a reference numeral 70. As shown in FIG. 13, this image decoder 70 includes an inverse formatter 71, arithmetic decoder 73, bit demodeling unit 74, code block synthesizer 75, dequantizer 76, adder 77, memory 78, selector 79 and wavelet inverse-transform unit 80. It should be noted here that the arithmetic decoder 73 and bit demodeling unit 74 form together an EBCOT decoder 72. Also note that the image decoder 70 corresponds to the image encoder 10 according to the first embodiment 10.

The inverse formatter 71 decomposes a supplied encoded code stream D70 into various coding information, and supplies an arithmetic code string D71 in each code block to the arithmetic decoder 73 included in the EBCOT decoder 72.

The arithmetic decoder 73 makes arithmetic decoding of the arithmetic code string D71 to generate a symbol and context D72 of each coefficient bit. The bit demodeling unit 74 restores binary data in units of a bit plate from the symbol and context D72 of each coefficient bit. The binary data is actually a quantization coefficient D73. The bit demodeling unit 74 supplies the quantization coefficient D73 to the code block synthesizer 75.

The code block synthesizer 75 synthesizes the quantization coefficient D73 of each code block to generate a quantization coefficient D74 of each frame, and supplies the quantization coefficient D74 of each frame to the dequantizer 76.

The dequantizer 76 dequantizes the quantization coefficient D74 of each frame, supplied from the code block synthesizer 75, into a wavelet transform coefficient D75, and supplies the wavelet transform coefficient D75 of each frame to the adder 77 and selector 79.

The adder 77 adds the wavelet transform coefficient D75 supplied from the dequantizer 76 and a wavelet transform coefficient D76 stored in the memory 78, and supplies an addition coefficient D77 to the selector 79.

Based on selection information included in a comment marker (COM), for example, of the encoded code stream D70, the selector 79 makes a selection between the wavelet transform coefficient D75 and addition coefficient D77, and supplies the selected wavelet transform coefficient or difference coefficient D78 to the wavelet inverse-transform unit 80. It should be noted that the wavelet transform coefficient or addition coefficient D78 is also supplied to the memory 78 in which it will be stored.

The wavelet inverse-transform unit 80 makes inverse transform of the wavelet transform coefficient or addition coefficient D78 to generate a final decoded image D79 and supplies the final decoded image D79 to outside.

As above, even if in the image encoder, a difference between the wavelet transform coefficient of a preceding frame and that of a current frame has been calculated and the intra- or inter-frame coding has been selected for each frame, the image decoder 70 according to the fourth embodiment can reconstruct an original decoded image by referring to selection information included in the encoded code stream D70. Especially, the image decoder 70 can decode data at a higher speed than with the MPEG technique because it makes calculation by addition without any motion prediction as in the MPEG technique.

### (5) Fifth Embodiment

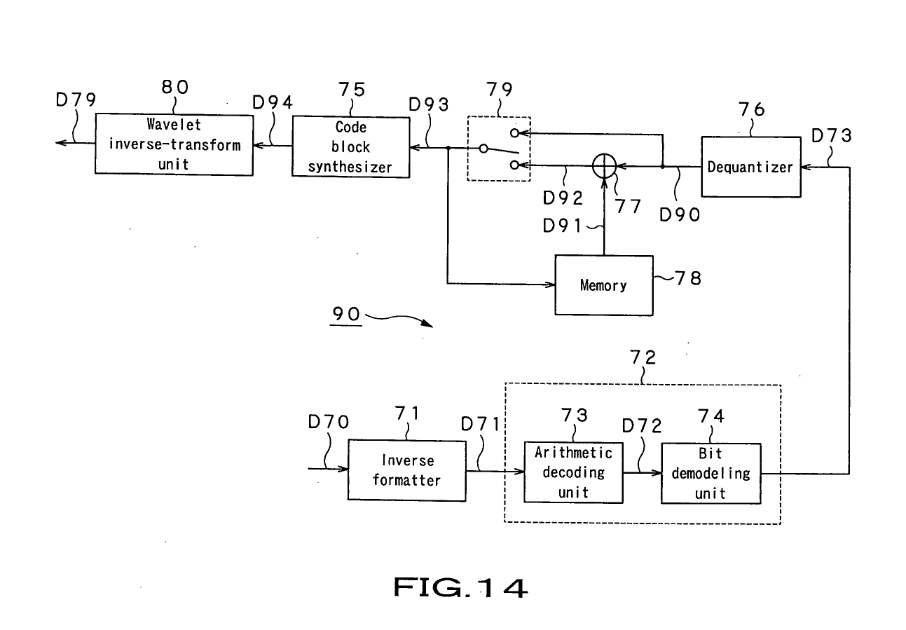

Referring now to FIG. 14, there is schematically illustrated in the form of a block diagram an image decoder according to the fifth embodiment of the present invention. The image decoder is generally indicated with a reference numeral 90. As shown in FIG. 14, the image decoder 90 is basically configured similarly to the image decoder 70 shown in FIG. 13 except for a code block synthesizer 75 disposed just before the wavelet inverse-transform unit 80 and calculation by addition for each code block. Therefore, the same or similar elements as or to those in the image decoder 70 shown in FIG. 13 are indicated with the same or similar reference numerals as or to those in FIG. 13 and will not be described in detail any longer. Also note that the image decoder 90 corresponds to the image encoder 30 according to the second embodiment.

In the above image decoder 90, the dequantizer 76 dequantizes the quantization coefficient D73 in each code block, supplied from the bit demodeling unit 74, into a wavelet transform coefficient D90 for each code block, and supplies the wavelet transform coefficient D90 to the adder 77 and selector 79.

The adder 77 adds the wavelet transform coefficient D90 supplied from the dequantizer 76 and a wavelet transform coefficient D91 stored in the memory 78, and supplies an addition coefficient D92 to the selector 79. It should be noted that the wavelet transform coefficient D91 is a coefficient of a code block in the same position as that of the wavelet transform coefficient D90 supplied from the dequantizer 76.

The selector 79 makes a selection between the wavelet transform coefficient D90 and addition coefficient D92 on the basis of selection information included in a comment marker (COM), for example, of the encoded code stream D70, and supplies the wavelet transform coefficient or addition coefficient D93 to the code block synthesizer 75. It should be noted that the wavelet transform coefficient or addition coefficient D93 is also supplied to the memory 78 in which it will be stored.

The code block synthesizer 75 synthesizes the wavelet transform coefficient or addition coefficient D93 in each code block to generate a wavelet transform coefficient D94 of each frame, and supplies the wavelet transform coefficient D94 of each frame to the wavelet inverse-transform unit 80.

The wavelet inverse-transform unit 80 makes inverse transform of the wavelet transform coefficient D94 of each frame into a final decoded image D79, and supplies the decoded image D79 to outside.

As above, even if in the image encoder, a difference between the wavelet transform coefficient of a preceding frame and that of a current frame has been calculated and the intra- or inter-frame coding has been selected for each frame, the image decoder 90 according to the fifth embodiment can reconstruct an original decoded image by referring to selection information included in the encoded code stream D70.

### (6) Sixth Embodiment

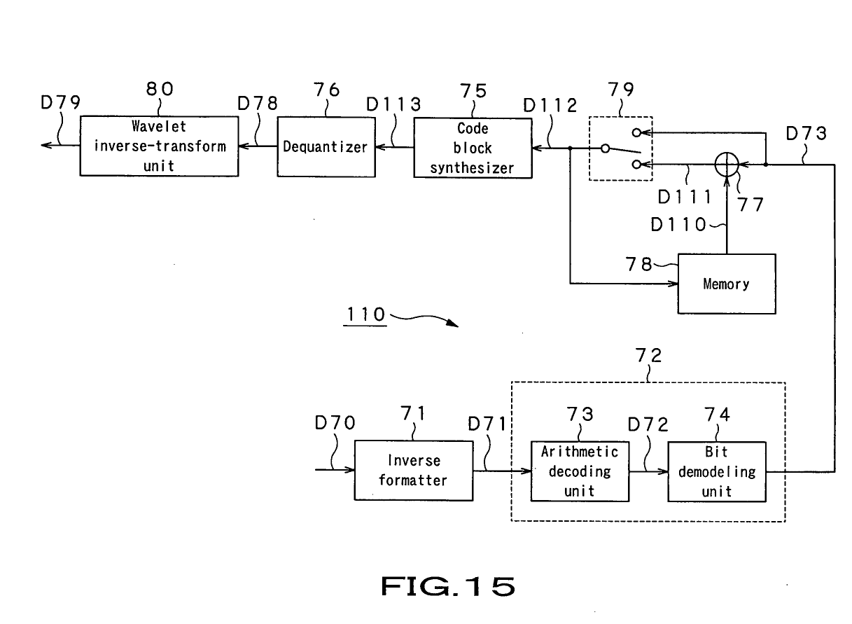

Referring now to FIG. 15, there is schematically illustrated in the form of a block diagram an image decoder according to the sixth embodiment of the present invention. The image decoder is generally indicated with a reference numeral 110. As shown in FIG. 15, the image decoder 110 is basically configured similarly to the image decoders 70 and 90 shown in FIGS. 13 and 14 except for a dequantizer 76 disposed immediately after the selector 79 and addition effected of quantization coefficients. Therefore, the same or similar elements as or to those in the image decoders 70 and 90 shown in FIGS. 13 and 14 are indicated with the same or similar reference numerals as or to those in FIGS. 13 and 14 and will not be described in detail any longer. Also note that the image decoder 110 corresponds to the image encoder 50 according to the third embodiment.

In the image decoder 110, the bit demodeling unit 74 supplies a quantization coefficient D73 in each block to the adder 77 and selector 79.

The adder 77 adds the quantization coefficient D73 in each code block, supplied from the bit demodeling unit 74, and a quantization coefficient D110 stored in the memory 78, and supplies an addition coefficient D111 to the selector 79. It should be noted that the quantization coefficient D110 is a coefficient of a code block in the same position as that of the quantization coefficient D73 supplied from the bit demodeling unit 74.

Based on selection information included in a comment marker (COM), for example, of the encoded code stream D70, the selector 79 makes a selection between the quantization coefficient D73 and addition coefficient D111, and supplies the selected quantization coefficient or addition coefficient D112 to the code block synthesizer 75. It should be noted that the quantization coefficient or addition coefficient D112 is also supplied to the memory 78 in which it will be stored.

The code block synthesizer 75 synthesizes the quantization coefficient or addition coefficient D112 in each code block to generate a quantization coefficient D113 of each frame, and supplies the quantization coefficient D113 to the dequantizer 76.

The dequantizer 76 dequantizes the quantization coefficient D113 of each frame, supplied from the code block synthesizer 75, into a wavelet transform coefficient D78, and supplies the wavelet transform coefficient D78 to the wavelet inverse-transform unit 80.

The wavelet inverse-transform unit 80 makes inverse transform of the wavelet transform coefficient D78 to generate a final decoded image D79, and supplies the decoded image D79 to outside.

As above, even if in the image encoder, a difference between the quantization coefficient of a preceding frame in the and that of a current frame has been calculated and the intra- or inter-frame coding has been selected for each frame, the image decoder 110 according to the sixth embodiment can reconstruct an original decoded image by referring to selection information included in the encoded code stream D70.

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims.

For example, in the aforementioned image encoders 10, 30 and 50, the rate control is made in units of a bit plane. However, the present invention is not limited to this processing but the rate control may be made in units of a coding pass.

1. An image encoder comprising:
a wavelet transform means for making wavelet transform of an input frame being one of a plurality of frames forming together a moving picture to generate a wavelet transform coefficient;
a difference calculating means for calculating a difference between the wavelet transform coefficient of the input frame and a wavelet transform coefficient of a preceding frame stored in a memory to generate a wavelet transform coefficient of a difference frame resulted from the calculation;
a selecting means for selecting and outputting either the wavelet transform coefficient of the input frame or that of the difference frame;
a quantizing means for quantizing the wavelet transform coefficient of the input frame or that of the difference frame supplied from the selecting means to generate a quantization coefficient;
a dequantizing means for dequantizing the quantization coefficient to generate a wavelet transform coefficient;
an updating means for updating the wavelet transform coefficient of the preceding frame stored in the memory by a wavelet transform coefficient resulted from addition of the wavelet transform coefficient generated by the dequantization and that of the preceding frame stored in the memory;
a code blocking means for breaking the quantization coefficient into a plurality of code blocks each having a predetermined size;
a bit plane developing means for developing the quantization coefficient of each code block into a plurality of bit planes from the most significant bit one to least significant bit one;
a coding pass generating means for making bit modeling of each of the bit planes to generate a coding pass;
an encoding means for making arithmetic coding of the coding pass generated by the coding pass generating means; and
a formatting means for formatting the arithmetic code generated by the encoding means to generate an encoded code stream.

2. The apparatus according to claim 1, wherein the selecting means makes a comparison between the absolute value sum of the wavelet transform coefficients of the input frame over the frame and absolute value sum of the wavelet transform coefficients of the difference frame over the frame to output either of the wavelet transform coefficients, whichever is smaller in absolute value sum.

3. The apparatus according to claim 1, further comprising a code amount controlling means for truncating some bit planes or coding pulses on the basis of the arithmetic code generated by the encoding means so that the code mount will be a predetermined target one.

4. The apparatus according to claim 3, wherein:
the code amount controlling means supplies truncation information as to the number of truncated bit planes or coding pulses to the dequantizing means; and
the dequantizing means dequantizes the quantization coefficient on the basis of the truncation information.

5. The apparatus according to claim 1, wherein the formatting means includes, in the encoded code stream, selection information indicative of which one of the wavelet transform coefficient of the input frame and that of the difference frame has been selected by the selecting means.

6. The apparatus according to claim 5, which encodes an input frame with the JPEG 2000 technique and wherein the formatting means describes the selection information by a comment marker in the encoded code stream.

7. The apparatus according to claim 1, wherein the difference calculating means does not calculate the difference at any predetermined number of frame intervals of the moving picture.

8. An image encoding method comprising the steps of:
making wavelet transform of an input frame being one of a plurality of frames forming together a moving picture to generate a wavelet transform coefficient;
calculating a difference between the wavelet transform coefficient of the input frame and a wavelet transform coefficient of a preceding frame stored in a memory to generate a wavelet transform coefficient of a difference frame resulted from the calculation;
selecting and outputting either the wavelet transform coefficient of the input frame or that of the difference frame;
quantizing the wavelet transform coefficient of the input frame or that of the difference frame supplied from the selecting step to generate a quantization coefficient;
dequantizing the quantization coefficient to generate a wavelet transform coefficient;
updating the wavelet transform coefficient of the preceding frame stored in the memory by the wavelet transform coefficient resulted from the addition of the wavelet transform coefficient generated by the dequantization and that of the preceding frame stored in the memory;
breaking the quantization coefficient into a plurality of code blocks each having a predetermined size;
developing the quantization coefficient of each code block into a plurality of bit planes from the most significant bit one to least significant bit one;
making bit modeling of each of the bit planes to generate a coding pass;
making arithmetic coding of the coding pass generated in the coding pass generating step; and
formatting the arithmetic code generated in the arithmetic encoding step to generate an encoded code stream.

9. An image encoder comprising:
a wavelet transform means for making wavelet transform of an input frame being one of a plurality of frames forming together a moving picture to generate a wavelet transform coefficient;
a code blocking means for breaking the wavelet transform coefficient into a plurality of code blocks each having a predetermined size;
a difference calculating means for calculating, for each of the code blocks, a difference between the wavelet transform coefficient of each code block of the input frame and a wavelet transform coefficient of a code block in the same position as that of a preceding frame stored in a memory to generate, for each code block, a wavelet transform coefficient of a difference frame resulted from the calculation;
a selecting means for selecting and outputting either the wavelet transform coefficient of the input frame or that of the difference frame for each code block;
a quantizing means for quantizing the wavelet transform coefficient of the input frame or that of the difference frame supplied from the selecting means to generate a quantization coefficient;
a dequantizing means for dequantizing the quantization coefficient to generate a wavelet transform coefficient;
an updating means for updating the wavelet transform coefficient of the preceding frame stored in the memory by a wavelet transform coefficient resulted from addition of the wavelet transform coefficient generated by the dequantization and that of the preceding frame stored in the memory;
a bit plane developing means for developing the quantization coefficient of each of the code blocks into a plurality of bit planes ranging from the most significant bit one to least significant bit one;
a coding pass generating means for making bit modeling of each of the bit planes to generate a coding pass;
an encoding means for making arithmetic coding of the coding pass generated by the coding pass generating means; and
a formatting means for formatting the arithmetic code generated by the encoding means to generate an encoded code stream.

10. The apparatus according to claim 9, wherein the selecting means makes a comparison between the absolute value sum of the wavelet transform coefficients of the input frame over the frame and that of the wavelet transform coefficients of the difference frame over the frame to output either of the wavelet transform coefficients, whichever is smaller in absolute value sum.

11. An image encoding method comprising the steps of:
making wavelet transform of an input frame being one of a plurality of frames forming together a moving picture to generate a wavelet transform coefficient;
breaking the wavelet transform coefficient into a plurality of code blocks each having a predetermined size;
calculating, for each of the code blocks, a difference between the wavelet transform coefficient of each code block of the input frame and a wavelet transform coefficient of a code block in the same position as that of a preceding frame stored in a memory to generate, for each code block, a wavelet transform coefficient of a difference frame resulted from the calculation;
selecting and outputting either the wavelet transform coefficient of the input frame or that of the difference frame for each code block;
quantizing the wavelet transform coefficient of the input frame or that of the difference frame supplied from the selecting step to generate a quantization coefficient;
dequantizing the quantization coefficient to generate a wavelet transform coefficient;
updating the wavelet transform coefficient of the preceding frame stored in the memory by a wavelet transform coefficient resulted from addition of the wavelet transform coefficient generated by the dequantization and that of the preceding frame stored in the memory;
developing the quantization coefficient of each of the code blocks into a plurality of bit planes ranging from the most significant bit one to least significant bit one;
making bit modeling of each of the bit planes to generate a coding pass;
making arithmetic coding of the coding pass generated in the coding pass generating step; and
formatting the arithmetic code generated in the encoding step to generate an encoded code stream.

12. An image encoding apparatus comprising:
a wavelet transform means for making wavelet transform of an input frame being one of a plurality of frames forming together a moving picture to generate a wavelet transform coefficient;
a quantizing means for quantizing the wavelet transform coefficient to generate a quantization coefficient;
a code blocking means for breaking the wavelet transform coefficient into a plurality of code blocks each having a predetermined size;
a difference calculating means for calculating, for each of the code blocks, a difference between the quantization coefficient of each code block of the input frame and a quantization coefficient of a code block in the same position as that of a preceding frame stored in a memory to generate, for each code block, a quantization coefficient of a difference frame resulted from the calculation;
a selecting means for selecting and outputting either the quantization coefficient of the input frame or that of the difference frame for each code block;
an updating means for updating the quantization coefficient of the preceding frame stored in the memory by a quantization coefficient resulted from addition of the quantization coefficient of the input frame or that of the difference frame supplied from the selecting means and that of the preceding frame stored in the memory;
a bit plane developing means for developing the quantization coefficient of each of the code blocks into a plurality of bit planes ranging from the most significant bit one to least significant bit one;
a coding pass generating means for making bit modeling of each of the bit planes to generate a coding pass;
an encoding means for making arithmetic coding of the coding pass generated by the coding pass generating means; and
a formatting means for formatting the arithmetic code generated by the encoding means to generate an encoded code stream.

13. The apparatus according to claim 12, wherein the selecting means makes a comparison between the absolute value sum of the quantization coefficients of the input frame over the code block and absolute value sum of the quantization coefficients of the difference frame over the code block to output either of the quantization coefficients, whichever is smaller in absolute value sum.

14. The apparatus according to claim 12, wherein the selecting means outputs one of the quantization coefficients in each code block of the input frame, which are developed in the plurality of bit planes, and that is smaller in number of bit planes finally included in the encoded code stream.

15. The apparatus according to claim 12, wherein the selecting means develops the quantization coefficients in each of code blocks of the input frame and difference frame, counts, for each of the bit planes, the number of coefficient bits whose value in the bit planes is “1” and whose value in the more significant bit planes is “0”, and outputs one of the quantization coefficients that is smaller in product of the count by a predetermined parameter.

16. An image encoding method comprising the steps of:
making wavelet transform of an input frame being one of a plurality of frames forming together a moving picture to generate a wavelet transform coefficient;
quantizing the wavelet transform coefficient of the input frame or that of the difference frame supplied from the selecting means to generate a quantization coefficient;
breaking the wavelet transform coefficient into a plurality of code blocks each having a predetermined size;
calculating, for each of the code blocks, a difference between the quantization coefficient of each code block of the input frame and a quantization coefficient of a code block in the same position as that of a preceding frame stored in a memory to generate, for each code block, a quantization coefficient of a difference frame resulted from the calculation;
selecting and outputting either the quantization coefficient of the input frame or that of the difference frame for each code block;
updating the quantization coefficient of the preceding frame stored in the memory by a quantization coefficient resulted from addition of the quantization coefficient of the input frame or that of the difference frame supplied from the selecting step and that of the preceding frame stored in the memory;
developing the quantization coefficient of each of the code blocks into a plurality of bit planes ranging from the most significant bit one to least significant bit one;
making bit modeling of each of the bit planes to generate a coding pass;
making arithmetic coding of the coding pass generated in the coding pass generating step; and
formatting the arithmetic code generated in the encoding step to generate an encoded code stream.

17. An image decoder which decodes an encoded code stream generated by sequentially encoding each of a plurality of frames forming together a moving picture, the apparatus comprising:
an inverse formatting means for decomposing the encoded code stream into at least an arithmetic code and predetermined parameter;
a decoding means for decoding the arithmetic code;
a coding pass decoding means for decoding a coding pass for each bit plane;
a code block reconstructing means for reconstructing a quantization coefficient of each code block on the basis of the bit planes ranging from the most significant bit one to least significant bit one;
a code block synthesizing means for collecting the quantization coefficient of each code block to generate a quantization coefficient of each frame;
a dequantizing means for dequantizing the quantization coefficient of each frame to generate a wavelet transform coefficient of each frame;
an adding means for adding the wavelet transform coefficient generated by the dequantizing means and wavelet transform coefficient of a preceding frame stored in a memory;
an updating means for updating the wavelet transform coefficient of the preceding frame stored in the memory by the wavelet transform coefficient resulted from the addition;
a selecting means for selecting and outputting either the wavelet transform coefficient generated by the dequantizing means or the wavelet transform coefficient resulted from the addition on the basis of the predetermined parameter; and
a wavelet inverse-transform means for making wavelet inverse-transform of the wavelet transform coefficient supplied from the selecting means to generate a decoded image.

18. The apparatus according to claim 17, wherein the predetermined parameter indicates which of the intra- or inter-frame coding has been made of each frame.

19. The apparatus according to claim 17, which encodes the encoded code stream with the JPEG 2000 technique and wherein the predetermined parameter is described with a comment marker in the encoded code stream.

20. An image decoding method for decoding an encoded code stream generated by sequentially encoding each of a plurality of frames forming together a moving picture, the method steps of:
decomposing the encoded code stream into at least an arithmetic code and predetermined parameter;
decoding the arithmetic code;
decoding a coding pass for each bit plane;
reconstructing a quantization coefficient of each code block on the basis of the bit planes ranging from the most significant bit one to least significant bit one;
collecting the quantization coefficient of each code block to generate a quantization coefficient of each frame;
dequantizing the quantization coefficient of each frame to generate a wavelet transform coefficient of each frame;
adding the wavelet transform coefficient generated in the dequantizing step and wavelet transform coefficient of a preceding frame stored in a memory;
updating the wavelet transform coefficient of the preceding frame stored in the memory by the wavelet transform coefficient resulted from the addition;
selecting and outputting either the wavelet transform coefficient generated in the dequantizing step or the wavelet transform coefficient resulted from the addition on the basis of the predetermined parameter; and
making wavelet inverse-transform of the wavelet transform coefficient supplied from the selecting step to generate a decoded image.

21. An image decoder which decodes an encoded code stream generated by sequentially encoding each of a plurality of frames forming together a moving picture, the apparatus comprising:
an inverse formatting means for decomposing the encoded code stream into at least an arithmetic code and predetermined parameter;
a decoding means for decoding the arithmetic code;
a coding pass decoding means for decoding a coding pass for each bit plane;
a code block reconstructing means for reconstructing a quantization coefficient of each code block on the basis of the bit planes ranging from the most significant bit one to least significant bit one;
a dequantizing means for dequantizing the quantization coefficient of each frame to generate a wavelet transform coefficient of each frame;
an adding means for adding the wavelet transform coefficient generated by the dequantizing means and wavelet transform coefficient of a code block in the same position as that of a preceding frame stored in a memory;
an updating means for updating the wavelet transform coefficient of a code block in the same position as that of the preceding frame stored in the memory by the wavelet transform coefficient resulted from the addition;
a selecting means for selecting and outputting either the wavelet transform coefficient generated by the dequantizing means or the wavelet transform coefficient resulted from the addition on the basis of the predetermined parameter;
a code block synthesizing means for collecting the wavelet transform coefficient supplied from the selecting means to generate a quantization coefficient of each frame; and
a wavelet inverse-transform means for making wavelet inverse-transform of the wavelet transform coefficient of each frame to generate a decoded image.

22. The apparatus according to claim 21, wherein the predetermined parameter indicates which of the intra- or inter-frame coding has been made of each code block.

23. An image decoding method for decoding an encoded code stream generated by sequentially encoding each of a plurality of frames forming together a moving picture, the method comprising the steps of:
decomposing the encoded code stream into at least an arithmetic code and predetermined parameter;
decoding the arithmetic code;
decoding a coding pass for each bit plane;
reconstructing a quantization coefficient of each code block on the basis of the bit planes ranging from the most significant bit one to least significant bit one;
dequantizing the quantization coefficient of each frame to generate a wavelet transform coefficient of each frame;
adding the wavelet transform coefficient generated by the dequantizing means and wavelet transform coefficient of a code block in the same position as that of a preceding frame stored in a memory;
updating the wavelet transform coefficient of a code block in the same position as that of the preceding frame stored in the memory by the wavelet transform coefficient resulted from the addition;
selecting and outputting either the wavelet transform coefficient generated by the dequantizing means or the wavelet transform coefficient resulted from the addition on the basis of the predetermined parameter;
collecting the wavelet transform coefficient supplied from the selecting means to generate a quantization coefficient of each frame; and
making wavelet inverse-transform of the wavelet transform coefficient of each frame to generate a decoded image.

24. An image decoder which decodes an encoded code stream generated by sequentially encoding each of a plurality of frames forming together a moving picture, the apparatus comprising:
an inverse formatting means for decomposing the encoded code stream into at least an arithmetic code and predetermined parameter;
a decoding means for decoding the arithmetic code;
a coding pass decoding means for decoding a coding pass for each bit plane;
a code block reconstructing means for reconstructing a quantization coefficient of each code block on the basis of the bit planes ranging from the most significant bit one to least significant bit one;
an adding means for adding the quantization coefficient of each code block, reconstructed by the code block reconstructing means and quantization coefficient of a code block in the same position as that of a preceding frame stored in a memory;
an updating means for updating the quantization coefficient of a code block in the same position as that of the preceding frame stored in the memory by the quantization coefficient resulted from the addition;
a selecting means for selecting and outputting either the quantization coefficient of each of the code blocks or quantization coefficient resulted from the addition on the basis of the predetermined parameter;
a code block synthesizing means for collecting the quantization coefficient supplied from the selecting means to generate a quantization coefficient of each frame;
a dequantizing means for dequantizing the quantization coefficient of each frame to generate a wavelet transform coefficient of each frame; and
a wavelet inverse-transform means for making wavelet inverse-transform of the wavelet transform coefficient of each frame to generate a decoded image.

25. The apparatus according to claim 24, wherein the predetermined parameter indicates which of the intra- or inter-frame coding has been made of each code block.

26. An image decoding method for decoding an encoded code stream generated by sequentially encoding each of a plurality of frames forming together a moving picture, the method comprising the steps of:
decomposing the encoded code stream into at least an arithmetic code and predetermined parameter;
decoding the arithmetic code;
decoding a coding pass for each bit plane;
reconstructing a quantization coefficient of each code block on the basis of the bit planes ranging from the most significant bit one to least significant bit one;
adding the quantization coefficient of each code block, reconstructed in the code block reconstructing step and quantization coefficient of a code block in the same position as that of a preceding frame stored in a memory;
updating the quantization coefficient of a code block in the same position as that of the preceding frame stored in the memory by the quantization coefficient resulted from the addition;
selecting and outputting either the quantization coefficient of each of the code blocks or quantization coefficient resulted from the addition on the basis of the predetermined parameter;
collecting the quantization coefficient supplied from the selecting step to generate a quantization coefficient of each frame;
dequantizing the quantization coefficient of each frame to generate a wavelet transform coefficient of each frame; and
making wavelet inverse-transform of the wavelet transform coefficient of each frame to generate a decoded image.
